(19) United States
(12) Patent Application Publication
(10) Pub. No.: US 2017/0282829 A1
(43) Pub. Date: Oct. 5, 2017

(54) WEIGHT-RESPONSIVE VEHICLE SEAT OCCUPANCY CLASSIFICATION SYSTEM

(71) Applicant: IEE INTERNATIONAL ELECTRONICS & ENGINEERING S.A., Echternach (LU)

(72) Inventors: Frank ALTHAUS, Saarbriicken (DE); Patrick DI MARIO COLA, Serrouville (FR); Arnaud MEURENS, Aubange (BE)

(73) Assignee: IEE INTERNATIONAL ELECTRONICS & ENGINEERING S.A., Echternach (LU)

(21) Appl. No.: 15/513,533

(22) PCT Filed: Sep. 22, 2015
(86) PCT No.: PCT/EP2015/071710

§ 371 Date: Mar. 22, 2017

(30) Foreign Application Priority Data
Sep. 22, 2014 (LU) LU 92 553

(51) Int. Cl. B60R 21/015; B60N 2/00

(52) U.S. Cl. CPC B60R 21/01516; B60N 2/002; B60R 21/01556; B60R 2021/01265

(57) ABSTRACT

A vehicle seat occupancy classification system having at least one weight-responsive sensor, including a supporting plate, a collecting plate, a hinge member mechanically connecting the supporting plate and the collecting plate, at least one elastic spring member, and a position sensor that is configured to determine a gap dimension between the supporting plate and the collecting plate. The occupancy seat classification system includes an evaluation unit that is configured to receive the output signal from the position sensor and to provide a seat occupant classification based on a level of the received output signal and at least a first pre-determined threshold value of the output signal.

### TECHNICAL FIELD

The invention relates to a weight-responsive vehicle seat occupant classification system, a method for classifying vehicle seat occupancy and a software module for carrying out the method.

### BACKGROUND ART

Vehicle seat occupancy detection systems are nowadays widely used in vehicles, in particular in passenger cars, for providing a seat occupancy signal for various appliances, for instance for the purpose of a seat belt reminder. Seat occupancy detection systems include seat occupancy sensors that are known to exist in a number of variants, e.g. based on capacitive sensing, on deformation sensing or on sensing of pressure/force. In order to meet requirements regarding easy integration and field robustness, weight-sensitive seat occupancy sensors have typically been arranged on the B-surface of a vehicle seat, i.e. between a foam body of a seat cushion and a seat pan or cushion-supporting springs of the vehicle seat.

Further, vehicle seat occupancy detection systems are known to be employed as a means of assessing a potential activation of an installed vehicle passenger restraint system, such as an airbag.

For example, patent U.S. Pat. No. 5,987,370 describes an apparatus for estimating the weight of an occupant of a seat in a motor vehicle. The apparatus includes a closed elastomeric bladder filled with fluid being installed in the foam cushion of a vehicle seat bottom. The apparatus includes at least one pressure sensor installed in a closed exit port of the bladder. A temperature sensor disposed in proximity to the bladder provides a temperature signal, and a controller estimates the weight of the occupant based on the temperature and pressure signals. The pressure sensor is configured to sense a differential pressure between the fluid and atmospheric pressure at the center of gravity of the fluid in order to provide a stable output independent of changing atmospheric pressure and changing orientation of the bladder due to vehicle pitch and roll. The estimated weight is used as the criteria to distinguish between an adult, an infant or small child in a child restraint system (CRS).

### SUMMARY

It is desirable to provide a vehicle seat occupant detection system with an improved performance with regard to classifying vehicle seat occupants for the purpose of enabling or disabling installed vehicle passenger restraint systems, such as airbags.

It is therefore an object of the invention to provide a vehicle seat occupant detection system that is capable of at least distinguishing a child in a cinched child seat arranged on a vehicle seat from an adult occupant of similar apparent weight.

In one aspect of the present invention, the object is achieved by a vehicle seat occupant classification system comprising at least one weight-responsive sensor, the at least one weight-responsive sensor including

a supporting plate that is fixable to a top surface of a seat pan and/or to a suspension of the seat pan,

a collecting plate that in at least one operational state is arranged substantially parallel to the supporting plate and, with regard to a direction of mechanical load to be applied perpendicular to the supporting plate by a seat occupant, between the supporting plate and a seat cushion of the vehicle seat,

a hinge member having an axis of articulation that is arranged parallel to the supporting plate, wherein the supporting plate and the collecting plate are mechanically connected by the hinge member so as to enable a rotational movement of the collecting plate relative to the supporting plate,

at least one elastic spring member that is arranged, with respect to the direction of mechanical load, between the collecting plate and the supporting plate in a distance to and is spaced from the axis of articulation, wherein the elastic spring force of the elastic spring member is configured to serve as a counteracting force for a mechanical load that is applied to the collecting plate in the direction of mechanical load, and

a position sensor that is configured to determine a gap dimension between the supporting plate and the collecting plate in a specified distance to the axis of articulation, and to provide an output signal that is indicative of the determined gap dimension.

The term “elastic spring member”, as used in this application, shall encompass spring members with linear-elastic behavior as well as spring members with nonlinear-elastic behavior, such as rubberlike materials.

As the elastic spring member provides a counteracting force that compensates the mechanical load applied to the collecting plate, the distance between the supporting plate and the collecting plate is indicative of the mechanical load that is applied to the collecting plate.

The vehicle seat occupant classification system further includes an evaluation unit that is configured to receive the output signal from the position sensor and to provide a seat occupant classification based on a level of the received output signal and at least a first pre-determined threshold value of the output signal.

The term “vehicle”, as used in this application, shall particularly be understood to encompass passenger cars, trucks and buses.

The classification may comprise at least two classes selected out of a group formed by classes “empty”, “small child in a CRS” and “adult”.

The classification provided by the vehicle seat occupant classification system can advantageously support the decision of enabling or disabling passenger restraint systems that are installed in the vehicle. In this way, the vehicle seat occupant classification system can contribute in complying with requirements from vehicle safety regulations, such as FMVSS (Federal Motor Vehicle Safety Standard) No. 208 concerning occupant crash protection.

Further advantage of the vehicle seat occupant classification system lies in that it inherently is less sensitive to activation by critically cinched child seats positioned at a back side of the seat cushion of the vehicle seat.

Another advantage lies in a low sensitivity to shear forces generated by a seat occupant in a direction from the back side of the seat cushion towards a front side of the seat cushion.

Further, the at least one weight-responsive sensor of the vehicle seat occupant classification system can be designed to have low sensitivity to temperature changes so that a system calibration can advantageously be confined to room temperature.

The position sensor may be based on either one out of or a combination of the following operating principles: capacitive, optical, eddy current, ultrasonic, magnetic and inductive. The position sensor may also be designed as a potentiometer implemented in a suitable electric circuit. Such position sensors are commercially available. The position sensor may also be based on a different operating principle that appears suitable to the person skilled in the art.

Preferably, the axis of articulation is arranged parallel to the supporting plate and perpendicular to a seating direction. The seating direction shall be defined as a direction being arranged in parallel to a passenger cabin floor of the vehicle, and being arranged perpendicular to and starting from an edge of the seat pan of the vehicle seat, wherein the edge is configured to support a lower thigh region of a sitting seat occupant. The seating direction corresponds to the driving direction of the vehicle. Terms like “front side”, “back side” or “rear edge”, as used in this application, shall be understood with reference to the seating direction.

In a preferred embodiment, the at least one weight-responsive sensor includes at least one elastic spring member that is spaced from the axis of articulation. In an embodiment the at least one weight-responsive sensor includes at least two elastic spring members that are spaced from each other and from the axis of articulation.

In this way a configuration of the supporting plate, the collecting plate and the elastic spring members can be provided that responses to an applied mechanical load in a robust, reliable and reproducible way.

In another preferred embodiment, the ratio of a maximum deflection of the at least one elastic spring member or the elastic spring members and a maximum deflection/deformation of the collecting plate in comparison to a mechanically unloaded shape of the collecting plate, upon applying a mechanical load in the direction of mechanical load to the collecting plate, is larger than 3.0, more preferably larger than 5.0 and, most preferably, larger than 8.0.

In this way, the collecting plate can be considered rigid in comparison to the elastic spring members, and the main effect of the applied mechanical load is a deflection of the spring member or the spring members, respectively. By that, the effect of the mechanical load is to a great extent transformed into a change of the distance between the supporting plate and collecting plate.

Preferably, the collecting plate substantially has a rectangular shape and may have rounded edges, and at least two of the at least two elastic spring members are disposed in corner regions of the collecting plate that are distal to the axis of articulation. Alternatively, the collecting plate may substantially have a circular or an elliptical shape that is clipped for connecting the collecting plate to the hinge member. In this case, at least two of the at least two elastic spring members are disposed in a region of the collecting plate that is distal to the axis of articulation and that has a dimension in the direction perpendicular to the axis of articulation of about one third of a diameter of the circle or about one third of the major axis or the minor axis of the ellipse.

In a preferred embodiment, a dimension of the collecting plate perpendicular to the seating direction is larger than 60 mm and less than 120 mm, and a dimension of the collecting plate parallel to the seating direction is larger than 80 mm and less than 150 mm. Provided that the collecting plate is suitably positioned, these plate dimensions are small enough to avoid a large weight-responsive sensor output signal in response to a critically cinched child seat, and large enough to collect most of the mechanical load from adults in most of the common seating positions.

In another preferred embodiment of the vehicle seat occupant classification system, the evaluation unit is configured to receive an input signal indicative of a status of activation of an automatic locking retractor (ALR) of the vehicle, and the classification is provided based on both a level of the received position sensor output signal and the indicated status of activation of the automatic locking retractor.

An automatic locking retractor of a seat belt installed in the vehicle allows the belt to be pulled in one motion until fastened, then operates as a ratchet, winding in slack and preventing further extension until completely rewound. The ALR is used to maintain high belt tension when installing a child seat. Therefore, as soon as it is activated, the assumption that a child seat is installed can be made, even if a misuse case is possible for human beings.

In this way, the robustness of the vehicle seat occupant classification system can be improved for high-cinched child retention systems (CRS) versus a lightweight human being in a due-care sitting position, which could potentially give a similar level of occupancy load, or even an overlap with a CRS.

In one embodiment, if the indicated ALR status of activation is negative, the classification is provided based on the level of the received position sensor output signal and a second pre-determined threshold value of the output signal. Further in such embodiment, if the indicated status of activation is positive, the classification is provided based on the level of the received position sensor output signal and a third pre-determined threshold value of the output signal.

In this way, a dynamic adaption of the threshold value can be accomplished, controlled by the input signal for the indicated status of activation.

In one embodiment, the second pre-determined threshold value of the output signal may be equal to the first pre-determined threshold value of the output signal.

In another preferred embodiment of the vehicle seat occupant classification system, the evaluation unit is configured to receive an input signal indicative of a status of a belt tension sensor (BTS) of the vehicle, and the classification is provided based on both a level of the received position sensor output signal and the indicated status of the BTS.

It is another object of the invention to provide a method for classifying an occupancy of a vehicle seat. The method comprises steps of

providing an embodiment of the vehicle seat occupant classification system disclosed herein,

installing the at least one weight-responsive sensor between a seat cushion and a seat pan and/or suspension of a seat pan of the vehicle seat, p comparing the level of the output signal of the position sensor with a first pre-determined threshold value, and

classify the occupancy of the vehicle seat as a first class if the level of the output signal falls below the first pre-determined threshold value, and as a second class if the level of the output signal is equal to or larger than the first pre-determined threshold value.

In another preferred embodiment, the method further comprises steps of

providing an input signal to the evaluation unit that is indicative of the status of activation of an automatic locking retractor of the vehicle,

if the status of activation is negative, classify the occupancy of the vehicle seat as a first class if the level of the output signal falls below a second pre-determined threshold value and as a second class if the level of the output signal is equal to or larger than the second pre-determined threshold value, and

if the status of activation is positive, classify the occupancy of the vehicle seat as a first class if the level of the output signal falls below a third pre-determined threshold value and as a second class if the level of the output signal is equal to or larger than the third pre-determined threshold value.

In one embodiment, the first pre-determined threshold value and the second pre-determined threshold value may be identical.

In another aspect of the invention, a vehicle seat is provided that comprises a seat structure supportable on the passenger cabin floor of a vehicle, a seat cushion, a seat pan having a top surface for receiving the seat cushion, a backrest, and an embodiment of the vehicle seat occupant classification system described herein, wherein the at least one weight-responsive sensor is arranged between the seat cushion and the seat pan (and/or suspension of a seat pan).

Preferably, at least one out of the seat cushion and the seat pan is furnished with a recess in a lower side of the seat cushion and the top surface of the seat pan, respectively, and the at least one weight-responsive sensor is fixable to the seat pan and is being received in the recess. In a suitable embodiment, a smooth upper surface can be provided for a seat occupant, and the existence of the weight-responsive sensor inside the vehicle seat can advantageously be concealed.

In yet another aspect of the invention, a software module for controlling an execution of steps of an embodiment of the method disclosed herein is provided.

The method steps to be conducted are converted into a program code of the software module, wherein the program code is implementable in a digital memory unit of the vehicle seat occupant classification system and is executable by a processor unit of the vehicle seat occupant classification system. Preferably, the digital memory unit and/or processor unit may be a digital memory unit and/or a processing unit of the evaluation unit of the vehicle seat occupant classification system. The processor unit may, alternatively or supplementary, be another processor unit that is especially assigned to execute at least some of the method steps.

The software module can enable a robust and reliable execution of the method and can allow for a fast modification of method steps.

These and other aspects of the invention will be apparent from and elucidated with reference to the embodiments described hereinafter.

### BRIEF DESCRIPTION OF THE DRAWINGS

Preferred embodiments of the invention will now be described, by way of example, with reference to the accompanying drawings, in which:

FIG. 1 schematically illustrates an embodiment of a vehicle seat occupant classification system;

FIG. 2 shows a schematic perspective view of the weight-responsive sensor pursuant to FIG. 1 to be installed in a vehicle seat; and

FIG. 3 shows a graphical representation of the classification by the vehicle seat occupant classification system in accordance with the invention, based on position sensor output signals and pre-determined threshold values for the mechanical load.

### DETAILED DESCRIPTION

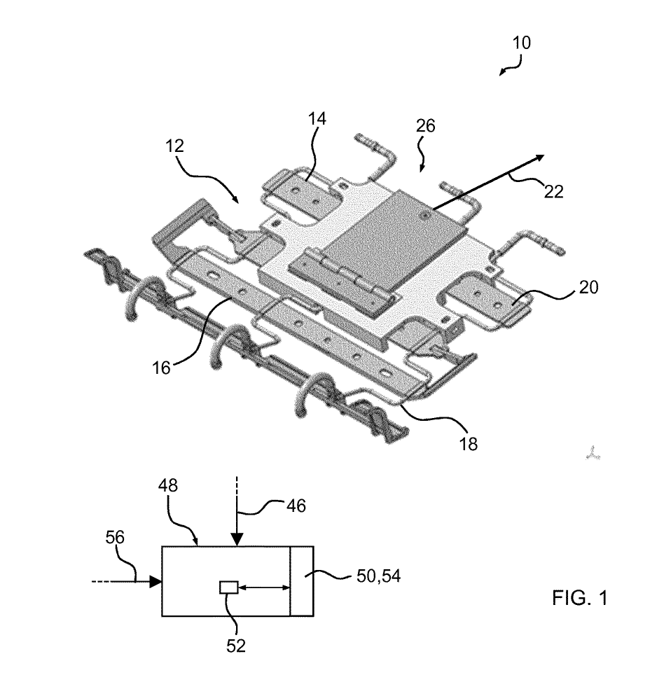

FIG. 1 schematically illustrates a partial view of a vehicle seat, in particular a passenger car seat, with an embodiment of a vehicle seat occupant classification system 10 in accordance with the invention. The vehicle seat comprises a seat structure (not shown) that is supportable on the passenger car cabin floor as is well known in the art. The vehicle seat further comprises a backrest (not shown) and a seat pan 12 that is mounted to the seat structure by a suspension 18. FIG. 1 is a view onto the vehicle seat from a position right behind the backrest.

The vehicle seat further includes a seat cushion (not shown) for comforting a seat occupant. The seat pan has a top surface for receiving the seat cushion. A back edge 16 of the seat pan is proximal to the backrest, and a front edge 14 of the seat pan, which is provided to support a lower thigh region of an adult seat occupant, is distal to the backrest. A seating direction 22 shall be defined pointing from the front edge 14 of the seat pan 12 in a direction that is perpendicular to the front edge 14 and horizontal to the cabin floor.

The vehicle seat is further equipped with a safety seat belt and an automatic locking retractor (both not shown) that allows to maintain high belt tension when installing a child seat.

The vehicle seat occupant classification system 10 includes a weight-responsive sensor 26 that is shown in FIG. 1 being installed in the vehicle seat. The weight-responsive sensor 26 includes a supporting plate 28 that is fixed in a substantially centered position to the top surface 20 of the seat pan 12 and to the seat pan suspension 18 by fixing members. As the person skilled in the art is aware of a plurality of suitable fixing members, no further specific details in this regard will be given herein.

The weight-responsive sensor 26 further includes a collecting plate 30 that in the ready-to-operate status shown in FIG. 1 is arranged parallel to the supporting plate 28 and in a mid-position with respect to a direction perpendicular to the seating direction 22 and parallel to the cabin floor. When the seat cushion is attached the vehicle seat, the collecting plate 30 is disposed, with regard to a direction 24 of mechanical load to be applied perpendicular to the collecting plate 30 by a seat occupant, between the supporting plate 28 and the seat cushion of the vehicle seat.

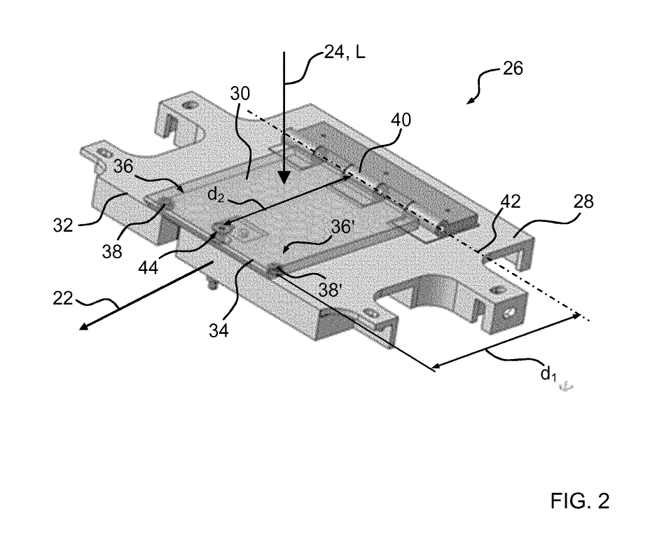

As can be seen best in FIG. 2, the supporting plate 28 and the collecting plate 30 are fixedly mounted to the two mutually movable sides of a hinge member 40. The hinge member 40 has an axis of articulation 42 that is arranged parallel to the supporting plate 28, disposed at a back side region of the supporting plate 28 that is proximal to the backrest and parallel to a rear edge of the supporting plate 28. In this way, the hinge member 40 enables a rotational movement of the collecting plate 30 relative to the supporting plate 28 about the axis of articulation 42.

The collecting plate 30 is of rectangular shape, with a shorter side of the rectangle fixedly mounted to the hinge member 18, and the opposite shorter edge of the rectangle, which is the front edge 34, being aligned with a front edge 32 of the supporting plate 28. The size of the rectangle is about 80 mm x 100 mm.

The weight-responsive sensor 26 comprises two elastic spring members 38, 38′ designed as metal springs that are disposed, with respect to the direction 24 of mechanical load, between the collecting plate 30 and the supporting plate 28, spaced from each other and spaced from the axis of articulation 42 by a distance d₁. Each elastic spring member 38, 38′ is located in a corner region 36, 36′ of the front edge 34 of the collecting plate. The elastic spring members 38, 38′ are designed such that with no mechanical load L applied to the vehicle seat, the collecting plate 30 and the supporting plate 28 form a gap between the front edge 34 of the collecting plate 30 and the front edge 32 of the supporting plate 28.

In a ready-to-operate state, the weight-responsive sensor 26 is arranged, in the direction 24 of mechanical load, between the seat cushion and the seat pan 12 of the vehicle seat.

In case of a mechanical load L being applied to the vehicle seat in the direction 24 of mechanical load, the mechanical load L is transferred via the seat cushion to the collecting plate 30, which will be rotated about the axis of articulation 42, reducing the height of the gap until the mechanical load L is compensated by the counteracting force of the deflected spring members 38, 38′. In this way, the gap height is a measure for the mechanical load L applied to the weight-responsive sensor 26 by a seat occupant, and the applied mechanical load L can be determined by measuring the gap height between the supporting plate 28 and the collecting plate 30 in a specified distance d₂ to the axis of articulation 42. A load vs. deflection characteristic of the combination of the two spring members 38, 38′ can readily be obtained in a calibration procedure.

To this end, the weight-responsive sensor 26 includes a position sensor 44 that is configured to determine the gap height between the supporting plate 28 and the collecting plate 30, and is arranged close to the front edge 32 of the supporting plate. In this embodiment, the function of the position sensor 44 is based on a capacitive operating principle, but any other position sensor may be employed that appears to be suitable to the person skilled in the art. The position sensor 44 is configured to provide an output signal 46 that is indicative of the determined gap height between the supporting plate 28 and collecting plate 30. Cabling to and from the position sensor 44 is omitted in FIG. 1 for clarity purposes.

Material and material thickness of the collecting plate 30 are selected such that in case of an applied mechanical load L in the direction 24 of mechanical load to the collecting plate 30, the ratio of a maximum deflection of each of the two elastic spring members 38, 38′ and a maximum deformation of the collecting plate 30 in comparison to a mechanically unloaded collecting plate 30 is larger than 25, so that the collecting plate 30 can be considered rigid compared to the elastic spring members 38, 38′.

Referring again to FIG. 1, the vehicle seat occupant classification system 10 further includes an evaluation unit 48 that is arranged in a remote position with regard to the vehicle seat. The evaluation unit 48 is configured to receive the output signal 46 from the position sensor 44 as a first input signal and to receive a signal 56 indicative of a status of activation of the automatic locking retractor of the vehicle seat as a second input signal.

The evaluation unit 48 is configured to provide a seat occupant classification based on a level of the received position sensor output signal 46, an indicated status of activation 56 and pre-determined threshold values tr₁, tr₂, tr₃ of the position sensor output signal 46, as will be described in more detail in the following.

In the following, an embodiment of a method for classifying an occupancy of the vehicle seat is described. In preparation of operating the vehicle seat occupant classification system 10, it shall be understood that all involved units and devices are in ready-to-operate state and configured accordingly.

In order to be able to carry out the method, the evaluation unit 48 comprises a software module 54 (FIG. 1). The method steps to be conducted are converted into a program code of the software module 54, wherein the program code is implementable in a digital memory unit 50 of the evaluation unit 48 and is executable by a processor unit 52 of the evaluation unit 48.

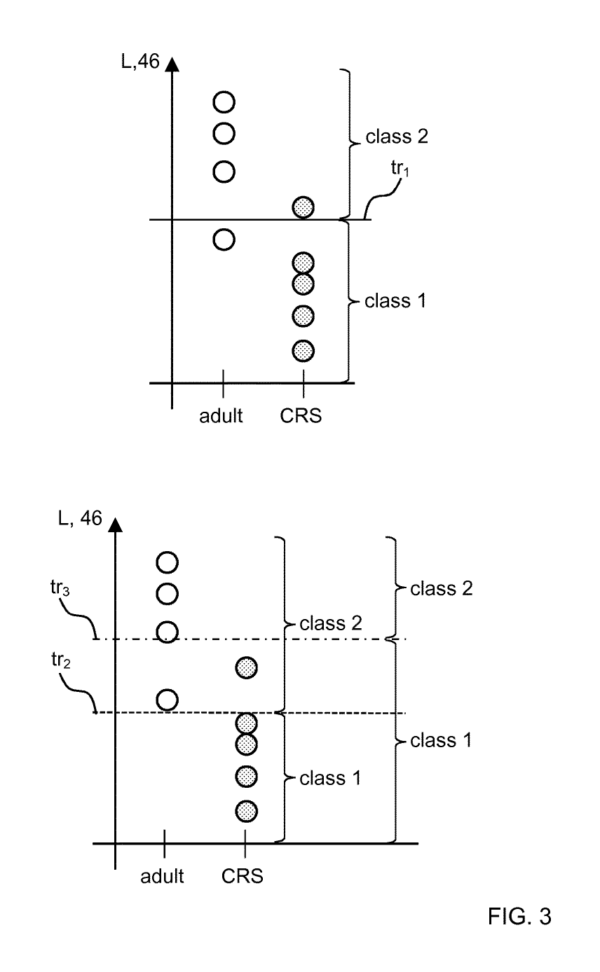

In a first step of the method, the level of the position sensor output signal 46 is compared with a first pre-determined threshold value tr₁ that is stored in the digital memory unit 50 of the evaluation unit 48. In a next step of the method, the evaluation unit 48 classifies the occupancy of the vehicle seat as a first class labeled “class 1” or “small child in a CRS” if the level of the position sensor output signal 46 falls below the first pre-determined threshold value tr₁, and as a second class labeled “class 2” or “adult” if the level of the position sensor output signal 46 is equal to or larger than the first pre-determined threshold value tr₁. In the upper part of FIG. 3, a graphical representation of the classification by the vehicle seat occupant classification system 10 according to this embodiment of the method is given.

In the first step of an alternative method for classifying an occupancy of the vehicle seat, the status of activation of the automatic locking retractor is checked by the evaluation unit 48. It is understood that the signal 56 indicative of the status of activation of the automatic locking retractor of the vehicle seat is provided to the evaluation unit 48.

In a next step of the method, the level of the position sensor output signal 46 is compared with a second pre-determined threshold value tr₂ and a third predetermined threshold value tr₃ that are stored in the digital memory unit 50 of the evaluation unit 48.

If the status of activation is negative, the evaluation unit 48 classifies the occupancy of the vehicle seat as a first class labeled “class 1” or “small child in a CRS” if the level of the position sensor output signal 46 falls below the second pre-determined threshold value tr₂, and as a second class labeled “class 2” or “adult” if the level of the position sensor output signal 46 is equal to or larger than the second pre-determined threshold value tr₂.

If the status of activation is positive, the evaluation unit 48 classifies the occupancy of the vehicle seat as a first class labeled “class 1” or “small child in a CRS” if the level of the position sensor output signal 46 falls below the third pre-determined threshold value tr₃, and as a second class labeled “class 2” or “adult” if the level of the position sensor output signal 46 is equal to or larger than the third pre-determined threshold value tr₃.

In the lower part of FIG. 3, a graphical representation of the classification by the vehicle seat occupant classification system 10 according to the alternative embodiment of the method is given.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

1. A vehicle seat occupancy classification system, comprising at least one weight-responsive sensor, including
a supporting plate that is fixable to a top surface of a seat pan and/or to a suspension of the seat pan,
a collecting plate that in at least one operational state is arranged substantially parallel to the supporting plate and, with regard to a direction of mechanical load to be applied perpendicular to the supporting plate by a seat occupancy, between the supporting plate and a seat cushion of the vehicle seat,
a hinge member having an axis of articulation that is arranged parallel to the supporting plate, wherein the supporting plate and the collecting plate are mechanically connected by the hinge member so as to enable a rotational movement of the collecting plate relative to the supporting plate and about the axis of articulation,
at least one elastic spring member that is disposed, with respect to the direction of mechanical load, between the collecting plate and the supporting plate and is spaced from the axis of articulation, wherein the elastic spring force of the elastic spring member is provided to serve as a counteracting force for a mechanical load that is applied to the collecting plate in the direction of mechanical load, and
a position sensor that is configured to determine a gap dimension between the supporting plate and the collecting plate in a specified distance to the axis of articulation , and to provide an output signal that is indicative of the determined gap dimension;
and an evaluation unit that is configured to receive the output signal from the position sensor and to provide a seat occupancy classification based on a level of the received output signal and at least a first pre-determined threshold value of the output signal.

2. The vehicle seat occupancy classification system as claimed in claim 1, wherein the at least one weight-responsive sensor includes at least one elastic spring member that is spaced from the axis of articulation .

3. The vehicle seat occupancy classification system as claimed in claim 1, wherein the at least one weight-responsive sensor includes at least two elastic spring members that are spaced from each other and from the axis of articulation.

4. The vehicle seat occupancy classification system as claimed in claim 1, wherein upon applying a mechanical load in the direction of mechanical load to the collecting plate, the ratio of a maximum deflection of the at least one elastic spring member and a maximum deflection/deformation of the collecting plate in comparison to a mechanically unloaded shape of the collecting plate is larger than 3.0.

5. The vehicle seat occupancy classification system as claimed in claim 1, wherein the evaluation unit is configured to receive an input signal indicative of a status of activation of an automatic locking retractor of the vehicle, and wherein the classification is provided based both on a level of the received position sensor output signal and the indicated status of activation of the automatic locking retractor.

6. The vehicle seat occupancy classification system as claimed in claim 1, wherein the classification is provided based on the level of the received position sensor output signal and a second pre-determined threshold value of the position sensor output signal, if the indicated status of activation is negative, and wherein the classification is provided based on the level of the received position sensor output signal and a third pre-determined threshold value of the position sensor output signal, if the indicated status of activation is positive.

7. The vehicle seat occupancy classification system as claimed in claim 1, wherein a dimension of the collecting plate perpendicular to a seating direction is larger than 60 mm and less than 120 mm, and a dimension of the collecting plate parallel to the seating direction is larger than 80 mm and less than 150 mm.

8. A method for classifying an occupancy of a vehicle seat, the method comprising steps of:
providing a vehicle seat occupancy classification system according to claim 1,
installing the at least one weight-responsive sensor between a seat cushion and a seat pan of the vehicle seat,
comparing the level of the position sensor output signal with a first pre-determined threshold value, and
classifying the occupancy of the vehicle seat as a first class if the level of the position sensor output signal falls below the first pre-determined threshold value, and as a second class if the level of the position sensor output signal is equal to or larger than the first pre-determined threshold value.

9. The method for classifying an occupancy of a vehicle seat as claimed in claim 8, further comprising steps of
providing an input signal to the evaluation unit that is indicative of the status of activation of an automatic locking retractor of the vehicle,
if the status of activation is negative, classifying the occupancy of the vehicle seat as a first class if the level of the position sensor output signal falls below a second pre-determined threshold value and as a second class if the level of the position sensor output signal is equal to or larger than the second pre-determined threshold value, and
if the status of activation is positive, classifying the occupancy of the vehicle seat as a first class if the level of the position sensor output signal falls below a third pre-determined threshold value and as a second class if the level of the position sensor output signal is equal to or larger than the third pre-determined threshold value.

10. A vehicle seat, comprising
a seat structure supportable on the passenger cabin floor of a vehicle,
a seat cushion,
a seat pan and/or suspension of a seat pan having a top surface for receiving the seat cushion,
a backrest,
a vehicle seat occupancy classification system as claimed in claim 1,
wherein the at least one weight-responsive sensor is arranged between the seat cushion and the seat pan and/or suspension of a seat pan.

11. The vehicle seat as claimed in claim 10, wherein at least one out of the seat cushion and the seat pan and/or suspension of a seat pan is furnished with a recess in a lower side of the seat cushion and the top surface of the seat pan and/or suspension of a seat pan, respectively, and the at least one weight-responsive sensor is fixable to the seat pan and is received in the recess.

12. A non-transitory digital memory unit comprising a software module having program code that is stored in the digital memory unit and that is executable by a processor unit of the vehicle seat occupancy classification system to carry out the method of claim 8.
